(19) United States
(12) Patent Application Publication
(10) Pub. No.: US 2021/0257145 A1
(43) Pub. Date: Aug. 19, 2021

(54) COIL DEVICE

(71) Applicant: TDK CORPORATION, Tokyo (JP)

(72) Inventors: Chen WANG, Tokyo (JP); Satoshi SUGIMOTO, Tokyo (JP); Leo YAO, Lincolnshire, IL (US)

(73) Assignee: TDK CORPORATION, Tokyo (JP)

(21) Appl. No.: 16/794,444

(22) Filed: Feb. 19, 2020

(51) Int. Cl. H01F 27/24; H01F 27/28

(52) U.S. Cl. CPC H01F 27/24; H01F 27/28

(57) ABSTRACT

A coil device includes a pair of first core and second core, a third core, and a pair of first coil and second coil. The third core is disposed next to the first core or the second core. The pair of first coil and second coil is each disposed between any two of the first core, the second core, and the third core next to each other. Plate surfaces of the first coil and the second coil are opposed to each other. Each of the first coil and the second coil is partly exposed in a lateral direction of the first core, the second core, or the third core.

### BACKGROUND OF THE INVENTION

The present invention relates to a coil device used as an inductor or so.

As a coil device used as an inductor or so, for example, a coil device of Patent Document 1 is known. The coil device of Patent Document 1 includes a pair of first core and second core and a third core disposed with a gap between the first core and the second core. A first coil is disposed between the first core and the third core, and a second coil is disposed between the second core and the third core. Since a gap is formed between the first core and the third core and between the second core and the third core, the magnetic coupling between the first coil and the second coil can be weak.

In the coil device of Patent Document 1, however, it is difficult to mount mountable parts of the first coil and the second coil on a mounting board with a sufficient mounting strength.
Patent Document 1: US2017178794 (A1)

### BRIEF SUMMARY OF INVENTION

The present invention has been achieved under such circumstances. It is an object of the invention to provide a coil device capable of sufficiently maintaining a mounting strength for a mounting board.

To achieve the above object, a coil device according to the present invention includes:

a pair of first core and second core;

a third core disposed next to the first core or the second core; and

a pair of first coil and second coil each disposed between any two of the first core, the second core, and the third core next to each other,

wherein plate surfaces of the first coil and the second coil are opposed to each other, and

wherein each of the first coil and the second coil is partly exposed in a lateral direction of the first core, the second core, or the third core.

In the coil device according to the present invention, each of the first coil and the second coil is partly exposed in a lateral direction of the first core, the second core, or the third core. In mounting the coil device, a solder fillet can thereby partly be formed on the first coil exposed in a lateral direction of any of the cores and the second coil exposed in a lateral direction of any of the cores, and the solder fillets can increase the mounting strength for the mounting board. In the present invention, it is thereby possible to achieve the coil device capable of sufficiently maintaining the mounting strength for the mounting board.

In the coil device according to the present invention, plate surfaces of the first coil and the second coil are opposed to each other. Thus, the first coil is disposed between the cores next to each other while the flat surfaces of the first coil are opposed to a perpendicular direction to the mounting board, and the second coil is disposed between the cores next to each other while the flat surfaces of the second coil are opposed to a perpendicular direction to the mounting board. Thus, the coil device can be thin in the array direction of the first core, the second core, and the third core, and the coil device can be downsized.

Preferably, the first coil includes a pair of plate-like first lateral parts and a plate-like first connection part connecting the pair of first lateral parts, and the second coil includes a pair of plate-like second lateral parts and a plate-like second connection part connecting the pair of second lateral parts. In this structure, the first coil and the second coil can easily be arranged between the cores next to each other, and the coil device is easily manufactured. When the first coil and the second coil have a plate shape, the coil device can be thin in the array direction of the first core, the second core, and the third core, and the coil device can effectively be downsized. Compared to when the first coil and the second coil are formed from wire, a large electric current can flow through the first coil and the second coil.

Preferably, each of the first connection part and the second connection part is disposed between any two of the first core, the second core, and the third core next to each other. Thus, the plate surfaces of the first connection part and the second connection part are arranged to face each other. As a result, the coil device can be thin in the array direction of the first core, the second core, and the third core, and the coil device can effectively be downsized.

Preferably, at least either of the first lateral parts faces a lateral surface of any of the first core, the second core, and the third core, and at least either of the second lateral parts faces a lateral surface of any of the first core, the second core, and the third core. Thus, each of the first lateral part and the second lateral part can widely be exposed to the laterals of any of the first core, the second core, and the third core. Thus, solder fillets can sufficiently be formed on the first lateral part and the second lateral part, and the solder fillets can effectively increase the mounting strength for the mounting board.

Preferably, at least either of the first lateral parts faces lateral surfaces of any two of the first core, the second core, and the third core, and at least either of the second lateral parts faces lateral surfaces of any two of the first core, the second core, and the third core. In this structure, when the coils and the cores are combined in the manufacture of the coil device, any two of the cores can laterally be fixed by the first lateral parts, and any two of the cores can laterally be fixed by the second lateral parts. Thus, the positions of the respective cores can be prevented from being shifted by the first lateral parts and the second lateral parts.

Preferably, at least either of the first lateral parts extends from a lateral surface to a bottom surface of any of the first core, the second core, and the third core, and at least either of the second lateral parts extends from a lateral surface to a bottom surface of any of the first core, the second core, and the third core. In this structure, a part of the first lateral part extending on the bottom surface of any of the cores can be connected as a mounting surface with the mounting board, and a part of the second lateral part extending on the bottom surface of any of the cores can be connected as a mounting surface with the mounting board.

Preferably, at least either of the first lateral parts extends from a lateral surface to a top surface of any of the first core, the second core, and the third core, and at least either of the second lateral parts extends from a lateral surface to a top surface of any of the first core, the second core, and the third core. In this structure, the mounting surface can be formed not only on the bottom surface of the coil device but on the top surface of the coil device. Thus, the coil device can be mounted on the mounting board even if the coil device is upside down (the top surface and the bottom surface are reversed), and the coil device is easily mounted.

Preferably, at least either of the first lateral parts extends from a lateral surface to an end surface of any of the first core, the second core, and the third core, and at least either of the second lateral parts extends from a lateral surface to an end surface of any of the first core, the second core, and the third core. A solder fillet can be formed on a part of the first lateral part located near the end surface of any of the cores, and a solder fillet can be formed on a part of the second lateral part located near the end surface of any of the cores. These solder fillets can increase the mounting strength for the mounting board.

Preferably, the first core, the second core, and the third core are formed to be long in a perpendicular direction to a board surface of a mounting board. In this structure, the width of the coil device can be smaller than the height of the coil device, and a plurality of coil devices can be mounted on the mounting board at high density.

Preferably, the first core has a first concave part through which the first coil passes, the second core has a second concave part through which the second coil passes, and the first concave part or the second concave part is formed to be shifted toward a bottom surface or a top surface of the first core or the second core. In this structure, the magnetic path of the first coil or the second coil can be changed, and magnetic characteristics of the coil device can be adjusted.

Preferably, the coil device further includes “n” number of cores corresponding to the first core or the second core. For example, the coil device having a high inductance value can be obtained by further adding “n” cores (“n” is the number of cores) corresponding to the first core or the second core and correspondingly adding “n” coils (“n” is the number of coils) corresponding to the first coil or the second coil. Even if the number of cores and coils is increased, the coil device can be downsized (space saving) by interposing each of the coils between the cores.

Preferably, any of the first core, the second core, and the third core includes split cores. In this structure, a gap can be formed between the split cores in combining them, and the magnetic coupling between the first coil and the second coil can be adjusted.

Preferably, the first core and the second core are made from magnetic material, and the third core is made from nonmagnetic material. When only the third core is made from nonmagnetic material, for example, the inductance value of the coil device can be adjusted to a desired value.

Preferably, the third core is disposed between the first core and the second core, the first coil is disposed between the first core and the third core, the second coil is disposed between the second core and the third core, the plate surfaces of the first coil and the second coil are opposed to each other with the third core interposed therebetween, the first coil is partly exposed in a lateral direction of the first core, and the second coil is partly exposed in a lateral direction of the second core. In this structure, it is possible to obtain the coil device with symmetry about the third core and favorable magnetic characteristics.

### BRIEF DESCRIPTION OF DRAWINGS

FIG. 1A is a perspective view of a coil device according to First Embodiment of the present invention.

FIG. 1B is a bottom view of the coil device shown in FIG. 1A.

FIG. 1C is a perspective view of a modified example of the coil device shown in FIG. 1A.

FIG. 2 is an exploded perspective view of the coil device shown in FIG. 1A.

FIG. 3A is a perspective view of a coil device according to Second Embodiment of the present invention.

FIG. 3B is a perspective view of a modified example of the coil device shown in FIG. 3A.

FIG. 4 is an exploded perspective view of the coil device shown in FIG. 3A.

FIG. 5A is a perspective view of a coil device according to Third Embodiment of the present invention.

FIG. 5B is a perspective view of a modified example of the coil device shown in FIG. 5A.

FIG. 6 is an exploded perspective view of the coil device shown in FIG. 5A.

FIG. 7 is a perspective view of a coil device according to Fourth Embodiment of the present invention.

FIG. 8 is an exploded perspective view of the coil device shown in FIG. 7.

FIG. 9 is a perspective view of a coil device according to Fifth Embodiment of the present invention.

FIG. 10 is an exploded perspective view of the coil device shown in FIG. 9.

FIG. 11 is a perspective view of a coil device according to Sixth Embodiment of the present invention.

FIG. 12 is a perspective view of a coil device according to Seventh Embodiment of the present invention.

FIG. 13 is a perspective view of a coil device according to Eighth Embodiment of the present invention.

### DETAILED DESCRIPTION OF INVENTION

Hereinafter, the present invention is explained based on embodiments shown in the figures.

### First Embodiment

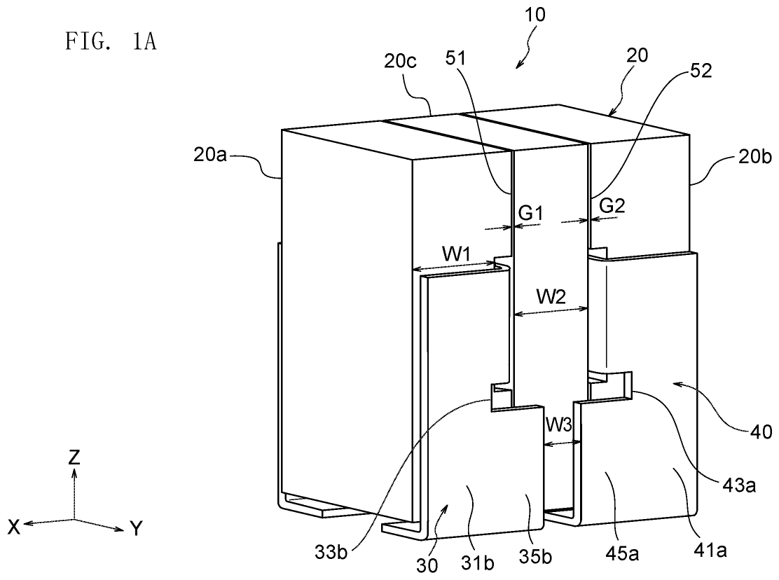

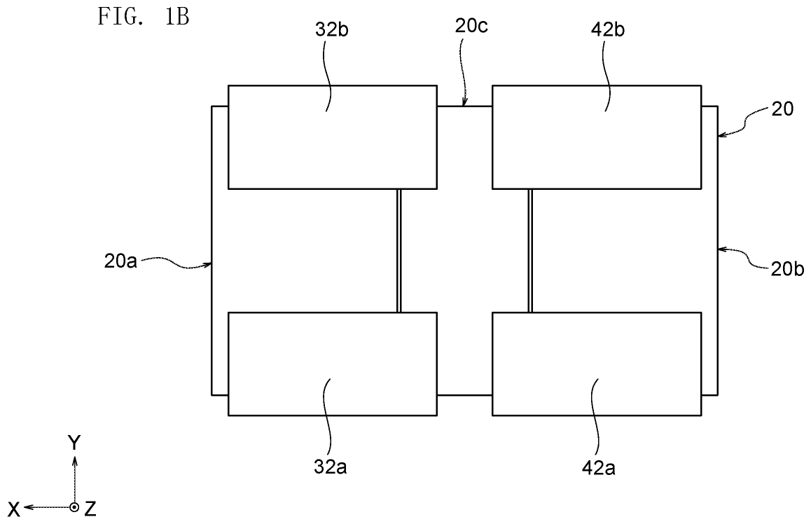

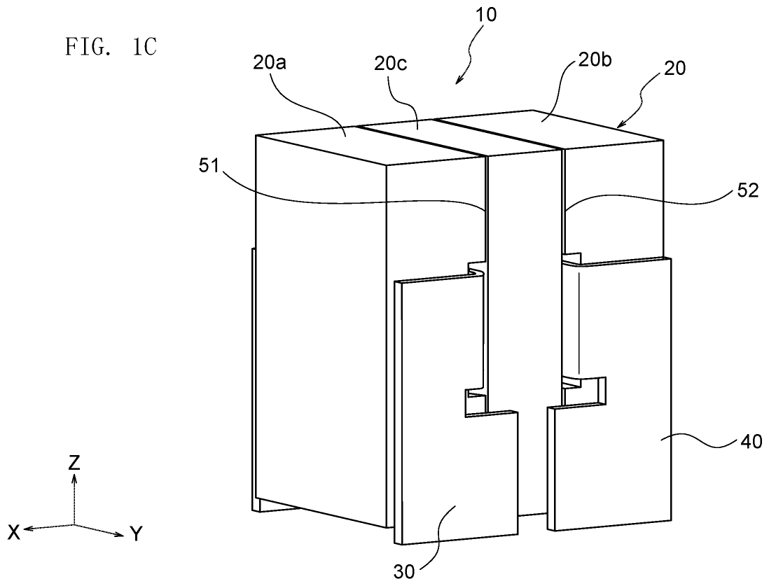

As shown in FIG. 1A, a coil device 10 includes a core 20 having a substantially rectangular parallelepiped outer shape as a whole and a pair of first coil 30 and second coil 40 at least partly arranged in the core 20. The coil device 10 is, for example, an inductor and has an array structure where the coils 30 and 40 are arrayed in the X-axis direction along with cores 20a, 20b, and 20c mentioned below. The coil device 10 has any size. For example, the coil device 10 can appropriately have a length of 3-20 mm in each of the X-axis direction, the Y-axis direction, and the Z-axis direction.

The core 20 is formed from a pair of first core 20a and second core 20b and a third core 20c disposed next to the first core 20a and the second core 20b in the X-axis direction. The core 20 is made from a magnetic material and is manufactured by, for example, molding and sintering a magnetic material having a comparatively high permeability (e.g., Ni—Zn based ferrite, Mn—Zn based ferrite) or a magnetic powder composed of a metal magnetic material or so. Incidentally, the core 20c may be made from a nonmagnetic material or a green compact containing a magnetic powder in resin. The cores 20a, 20b, and 20c may have mutually different permeabilities.

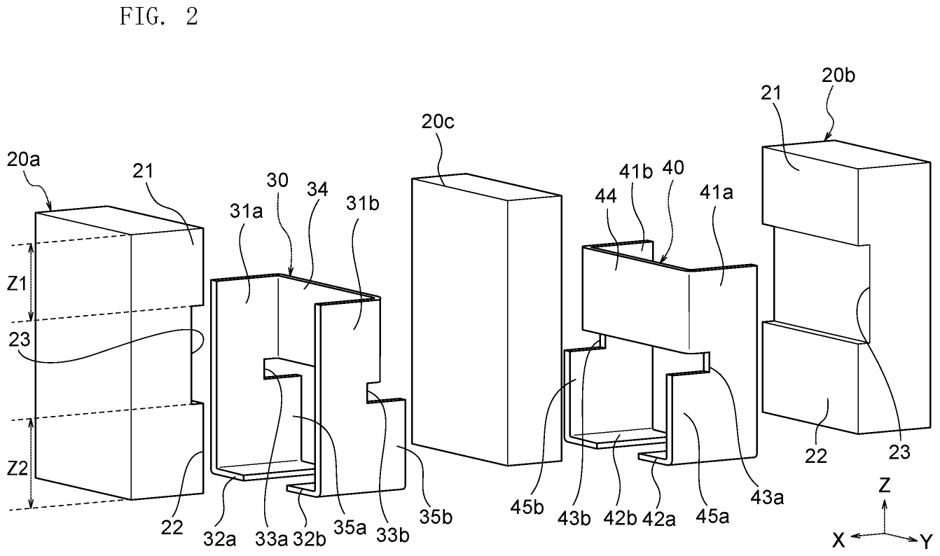

The first core 20a and the second core 20b have a mutually corresponding (symmetrical) shape. In the illustrated example, the first core 20a and the second core 20b have the same shape. As shown in FIG. 2, the core 20a (20b) has a substantially rectangular parallelepiped shape being longer in the Z-axis direction (the height direction of the coil device 10 or the perpendicular direction to the board surface of the mounting board) and is formed from a C-shaped or U-shaped core. The core 20a (20b) has a first outer leg part 21, a second outer leg part 22, and a concave part 23.

The first outer leg part 21 is formed at the upper end of the core 20a (20b) in the Z-axis direction, and the second outer leg part 22 is formed at the lower end of the core 20a (20b) in the Z-axis direction. The length Z1 of the first outer leg part 21 in the Z-axis direction and the length Z2 of the second outer leg part 22 in the Z-axis direction are equal to each other, but Z2>Z1 may be accepted. In this case, the position of the concave part 23 can be shifted toward the top surface of the core 20a (20b), and magnetic saturation of the coil device 10 can effectively be prevented. Z2<Z1 may also be accepted. In this case, since the position of the concave part 23 can be shifted toward the bottom surface of the core 20a (20b), the coil 30 becomes shorter (particularly, a length of a first lateral part 31a (31b) mentioned below in the Z-axis direction), and DC resistance of the coil 30 can correspondingly be lowered. The first outer leg parts 21 and 22 of the first core 20a are projecting toward one side in the X-axis direction, and the first outer leg parts 21 and 22 of the second core 20b are projecting toward the other side in the X-axis direction.

The concave part 23 is formed between the first outer leg part 21 and the first outer leg part 22. The width of the concave part 23 in the Z-axis direction is substantially equal to or larger than a width of a connection part 34 (44) of the coil 30 (40) mentioned below. The depth of the concave part 23 in the X-axis direction is substantially equal to or larger than a thickness of the coil 30 (40) (board thickness) mentioned below. As shown in FIG. 1A and FIG. 2, a ratio W2/W1 of a width W2 of the third core 20c in the X-axis direction to a width W1 of the first core 20a in the X-axis direction at the concave part 23 is preferably 0.5-1 (more preferably, 1). A cross-sectional area of the first core 20a in cutting it on a perpendicular plane to the Z-axis at the concave part 23 is smaller than that at another part.

The first core 20a and the third core 20c are combined by bonding at least either of the outer leg parts 21 and 22 of the first core 20a and an end surface (front surface) of the third core 20c on the other side in the X-axis direction with a bonding material (e.g., adhesive). The second core 20b and the third core 20c are combined by bonding at least either of the outer leg parts 21 and 22 of the second core 20b and an end surface (front surface) of the third core 420c on one side in the X-axis direction with a bonding material (e.g., adhesive).

For example, when a Micropearl (Sekisui Chemical Co., Ltd.) or a resin containing resin beads is used, a first gap 51 (see FIG. 1A) mentioned below can easily be formed between the first core 20a and the third core 20c, and a second gap 52 (see FIG. 1A) mentioned below can easily be formed between the second core 20b and the third core 20c.

In a state where the cores 20a, 20b, and 20c are combined, the first gap 51 is formed in the Z-axis direction between the outer leg parts 21 and 22 of the first core 20a and the end surface of the third core 20c, and the second gap 52 is formed in the Z-axis direction between the outer leg parts 21 and 22 of the second core 20b and the end surface of the third core 20c. Preferably, each of the width G1 of the first gap 51 in the X-axis direction and the width G2 of the second gap 52 in the X-axis direction is 0.03-0.3 mm. Incidentally, the width G1 and the width G2 may be different from each other.

Due to the first gap 51 formed between the first core 20a and the third core 20c and the second gap 52 formed between the second core 20b and the third core 20c, magnetic coupling between the first coil 30 and the second coil 40 can effectively be prevented.

As shown in FIG. 2, the concave part 23 is formed at a substantially central part of the core 20a (20b) in the Z-axis direction. The connection part 34 of the first coil 30 can be inserted into (pass through) the concave part 23 of the first core 20a. The connection part 44 of the second coil 40 can be inserted into (pass through) the concave part 23 of the second core 20b.

The third core 20c has a rectangular parallelepiped shape being longer in the Z-axis direction and is formed from an I-shaped (flat shape) core. The third core 20c is disposed to be interposed by the first core 20a and the second core 20b in the X-axis direction. While the third core 20c is interposed, the second core 20b is disposed outside the second coil 40 disposed on one side in the X-axis direction, and the first core 20a is disposed outside the first coil 30 disposed on the other side in the X-axis direction.

The first coil 30 and the second coil 40 have a mutually corresponding (symmetrical) shape. In the illustrated example, the first coil 30 and the second coil 40 have the same shape. The second coil 40 is what the first coil 30 is rotated around the Z-axis by 180 degrees.

For example, the coils 30 and 40 are made from a metal good conductor of copper, copper alloy, silver, nickel, etc., but may be made from any other conductor material. For example, the coils 30 and 40 are formed by machining a metal plate (conductor plate), but the coils 30 and 40 may be formed by any other method. In the illustrated example, the coil 30 (40) has a substantially U shape as a whole and is longer in the Y-axis direction than in the X-axis direction and in the Z-axis direction. That is, the coil 30 (40) has a shape being longer in the Z-axis direction.

At least a part of the first coil 30 is disposed between the first core 20a and the third core 20c next to each other, and at least a part of the second coil 40 is disposed between the second core 20b and the third core 20c next to each other. The first coil 30 has a pair of first lateral parts 31a and 31b, a pair of first concave parts 33a and 33b, and a first connection part 34.

The first lateral part 31a (31b) has a plate shape (flat shape) parallel to the XZ plane and is longer in the Z-axis direction. The first lateral part 31a (31b) extends downward in the Z-axis direction from the first connection part 34. The first lateral parts 31a and 31b are opposed to each other with a predetermined distance in the Y-axis direction. The distance between the first lateral part 31a and the first lateral part 31b is substantially equal to or larger than the width of the core 20 in the Y-axis direction. A space (clearance) may be formed between the first lateral part 31a (31b) and the lateral surface of the core 20 (the lateral surface in the Y-axis direction). Instead, the lateral surfaces of the core 20 may be interposed by the first lateral parts 31a and 31b.

The first lateral part 31a (31b) has a first mountable part 32a (32b) and a first lateral protrusion part 35a (35b). The first lateral protrusion part 35a (35b) has a plate shape (flat shape) parallel to the XZ plane and extends in the Z-axis direction from a substantially central part to the lower end of the first lateral part 31a (31b) in the Z-axis direction. The first lateral protrusion part 35a (35b) is more projecting than the first connection part 34 in the X-axis direction (toward one side in the X-axis direction). Incidentally, the first lateral protrusion part 35a (35b) corresponds to a part of the first lateral part 31a (31b) that is more projecting than the base (bottom) of the first concave part 33a (33b) mentioned below toward one side in the X-axis direction. The part of the first lateral part 31a (31b) excluding the first lateral protrusion part 35a (35b) is a main part of the first lateral part 31a (31b).

As shown in FIG. 1A, the first lateral protrusion part 35a (35b) (the first lateral protrusion part 35a is not illustrated, though) is disposed at the lower ends of the first core 20a and the third core 20c in the Z-axis direction so as to range over the lateral surfaces of the cores 20a and 20c in the X-axis direction. That is, the lateral surfaces of the cores 20a and 20c are at least partly covered with the first lateral protrusion part 35a (35b) at the lower ends of the cores 20a and 20c.

A space is formed between the end of the first lateral part 31a (31b) on the other side (positive side) in the X-axis direction and the end surface of the first core 20a on the other side in the X-axis direction. That is, the first lateral part 31a (31b) does not extend to the end surface of the first core 20a on the other side in the X-axis direction, but only extends to the inner side of this end surface.

In the present embodiment, the first coil 30 is partly (first lateral parts 31a and 31b) exposed (arranged) to the lateral (outside) of the first core 20a and the third core 20c in the Y-axis direction. The first lateral part 31a (31b) (including the first lateral protrusion part 35a (35b)) is opposed to the lateral surfaces of the first core 20a and the third core 20c. As a result, the first core 20a and the third core 20c are arranged to be interposed in the Y-axis direction by the first lateral parts 31a and 31b (including the first lateral protrusion parts 35a and 35b) laterally exposed in the Y-axis direction.

As shown in FIG. 2, the first mountable part 32a (32b) has a plate shape (flat shape) parallel to the XY plane and is longer in the X-axis direction (the longitudinal direction of the coil device 10). For example, the first mountable part 32a (32b) is formed by bending the first lateral part 31a (31b) from the Z-axis direction to the Y-axis direction at a substantially right angle. As shown in FIG. 1A, a space is formed between the first mountable part 32a (32b) and the core 20 in the Z-axis direction. In the present embodiment, the first lateral part 31a (31b) thereby extends from the lateral surfaces to the bottom surfaces of the first core 20a and the third core 20c via the first mountable part 32a (32b).

As shown in FIG. 1B, the first mountable parts 32a and 32b extend toward the inner side in the Y-axis direction so as to approach each other on the bottom side of the core 20. The first mountable parts 32a and 32b are arranged to range over the bottom surfaces of the cores 20a and 20c.

A space is formed between the end of the first mountable part 32a (32b) on the positive side in the X-axis direction and the end surface of the first core 20a on the positive side in the X-axis direction. That is, the first mountable part 32a (32b) does not extend to the end surface of the first core 20a on the positive side in the X-axis direction, but extends only to the inner side of this end surface.

The first mountable part 32a (32b) is connected with a land pattern of the mounting board by a bonding material of solder, conductive adhesive, etc., and the coil device 10 can be connected with the mounting board via the first mountable parts 32a and 32b. At this time, a solder fillet can be formed on the outer surface of the first lateral part 31a (31b) in the Y-axis direction.

As shown in FIG. 2, the first connection part 34 has a plate shape (flat shape) parallel to the YZ plane and is longer in the Y-axis direction (the width direction of the coil device 10). The first connection part 34 is disposed to face the surfaces (flat surfaces) of the first core 20a and the third core 20c. The first connection part 34 connects the pair of first lateral parts 31a and 31b in the surroundings of the upper ends of the first lateral parts 31a and 31b on one end in the X-axis direction. The first connection part 34 and the pair of first lateral parts 31a and 31b are substantially perpendicular to each other. The first connection part 34 is disposed between the first core 20a and the third core 20c next to each other.

The first concave part 33a (33b) is formed at a substantially central part in the Z-axis direction on one end of the first lateral part 31a (31b) in the X-axis direction. The first concave part 33a (33b) is dented toward the other side in the X-axis direction. Due to the first concave part 33a (33b), the first lateral part 31a (31b) has a locally small width in the X-axis direction. As shown in FIG. 1A, the lateral of the first core 20a in the Y-axis direction is locally exposed at the position of the first concave part 33a (33b) (the first concave part 33a is not illustrated, though).

As shown in FIG. 2, the second coil 40 has a pair of plate-like second lateral parts 41a and 41b, a pair of second concave parts 43a and 43b, and a plate-like second connection part 44 connecting the pair of second lateral parts 41a and 41b. The second lateral part 41a (41b) has a second lateral protrusion part 45a (45b) and a second mountable part 42a (42b). Since the structure of each part of the second coil 40 is similar to that of the first coil 30 mentioned above, their overlapping matters are not explained in detail.

As shown FIG. 1A, the second lateral protrusion part 45a (45b) (the second lateral protrusion part 45b is not illustrated, though) is disposed at the lower ends of the second core 20b and the third core 20c in the Z-axis direction so as to range over the lateral surfaces of the cores 20b and 20c in the X-axis direction. That is, the lateral surfaces of the cores 20b and 20c are at least partly covered with the second lateral protrusion part 45a (45b) at the lower ends of the cores 20b and 20c.

Although not illustrated in detail, a space is formed between the end of the second lateral part 41a (41b) on one side (negative side) in the X-axis direction and the end surface of the second core 20b on one side in the X-axis direction. That is, the second lateral part 41a (41b) does not extend to the end surface of the second core 20b on one side in the X-axis direction, but extends only to the inner side of this end surface.

In the present embodiment, the second coil 40 is partly (second lateral parts 41a and 41b) exposed (arranged) to the lateral (outside) of the second core 20b and the third core 20c in the Y-axis direction. The second lateral part 41a (41b) (including the second lateral protrusion part 45a (45b)) is opposed to the lateral surfaces of the second core 20b and the third core 20c. As a result, the second core 20b and the third core 20c are arranged to be interposed in the Y-axis direction by the second lateral parts 41a and 41b (including the second lateral protrusion parts 45a and 45b) laterally exposed in the Y-axis direction.

As shown in FIG. 1B, the second mountable part 42a (42b) is disposed to range over the bottom surfaces of the cores 20b and 20c in the X-axis direction. A space is formed between the end of the second mountable part 42a (42b) on the negative side in the X-axis direction and the end surface of the second core 20b on the negative side in the X-axis direction. That is, the second lateral part 42a (42b) does not extend to the end surface of the second core 20b in the X-axis direction, but extends only to the inner side of this end surface.

In the present embodiment, as shown in FIG. 1A, the second lateral part 41a (41b) extends from the lateral surfaces to the bottom surfaces of the second core 20b and the third core 20c via the second mountable part 42a (42b). The second connection part 44 is disposed between the second core 20b and the third core 20c next to each other and is disposed to face the surfaces (flat surfaces) of the second core 20b and the third core 20c.

The plate surfaces of the first core 30 and the second coil 40 are opposed to each other in the X-axis direction. For more detail, as shown in FIG. 2, the first connection part 34 of the first coil 30 is opposed to the second connection part 44 of the second coil 40 with the third core 20c interposed therebetween in the X-axis direction. The first connection part 34 is disposed between the first core 20a and the third core 20c arranged next to each other, and the second connection part 44 is disposed between the second core 20b and the third core 20c arranged next to each other. As shown in FIG. 1A and FIG. 2, the distance between the first connection part 34 and the second connection part 44 in the X-axis direction is substantially equal to or larger than the length of the third core 20c in the X-axis direction.

As shown in FIG. 1A, the first lateral protrusion part 35b (35a) and the second lateral protrusion part 45a (45b) are arranged with a distance in the X-axis direction. Preferably, the ratio W3/W2 of the distance W3 between the first lateral protrusion part 35b (35a) and the second lateral protrusion part 45a (45b) in the X-axis direction to the width W2 of the third core 20c in the X-axis direction is 0.1-0.8 (more preferably, 0.3-0.5).

In the manufacture of the coil device 10, prepared are the cores 20a, 20b, and 20c, the first coil 30, and the second coil 40 shown in FIG. 1A. Then, the cores 20a, 20b, and 20c are combined while the coils 30 and 40 are contained. At this time, as shown in FIG. 2, the first coil 30 is interposed by the first core 20a and the third core 20c so that the first connection part 34 is inserted into the concave part 23 of the first core 20a, and the second coil 40 is interposed by the second core 20b and the third core 20c so that the second connection part 44 is inserted into the concave part 23 of the second core 20b. The coils 30 and 40 may be fixed to the cores 20a, 20b, and 20c with adhesive or so.

Next, the first outer leg part 21 and/or the second outer leg part 22 of the first core 20a and the flat surface of the third core 20c on the other side in the X-axis direction are bonded with adhesive or so, and the first outer leg part 21 and/or the second outer leg part 22 of the second core 20b and the flat surface of the third core 20c on one side in the X-axis direction are bonded with adhesive or so. Then, the coil device 10 shown in FIG. 1A is obtained.

In the coil device 10 according to the present embodiment, the first coil 30 is partly (first lateral part 31a (31b)) exposed to the laterals of the cores 20a and 20c, and the second coil 40 is partly (second lateral part 41a (41b)) exposed to the laterals of the cores 20b and 20c. In mounting the coil device 10, a solder fillet can thereby be formed on each of the first lateral part 31a (31b) exposed to the laterals of the cores 20a and 20c and the second lateral part 41a (41b) exposed to the laterals of the cores 20b and 20c, and the solder fillets can increase the mounting strength for the mounting board. In the present embodiment, it is thereby possible to achieve the coil device 10 capable of sufficiently maintaining the mounting strength for the mounting board.

In the coil device 10 according to the present embodiment, the plate surfaces of the first coil 30 (first connection part 34) and the second coil 40 (second connection part 44) are opposed to each other. Thus, the first coil 30 is disposed between the cores 20a and 20c next to each other while the flat surfaces of the first coil 30 are opposed to a perpendicular direction to the mounting board, and the second coil 40 is disposed between the cores 20b and 20c next to each other while the flat surfaces of the second coil 40 are opposed to a perpendicular direction to the mounting board. Thus, the coil device 10 can be thin in the array direction of the first core 20a, the second core 20b, and the third core 20c, and the coil device 10 can be downsized.

In the present embodiment, the first coil 30 has the pair of first lateral parts 31a and 31b and the first connection part 34, and the second coil 40 has the pair of second lateral parts 41a and 41b and the second connection part 44. Thus, the first coil 30 is easily disposed between the cores 20a and 20c next to each other, the second coil 40 is easily disposed between the cores 20b and 20c next to each other, and the coil device 10 is easily manufactured. Since the first coil 30 and the second coil 40 have a plate shape, the coil device 10 can be thin in the array direction of the first core 20a, the second core 20b, and the third core 20c, and the coil device 10 can effectively be downsized. Compared to when the first coil 30 and the second coil 40 are formed from wire, a large electric current can flow through the first coil 30 and the second coil 40.

In the present embodiment, the first connection part 34 is disposed between the first core 20a and the third core 20c next to each other, and the second connection part 44 is disposed between the second core 20b and the third core 20c next to each other. Thus, the plate surfaces of the first connection part 34 and the second connection part 44 are arranged to face each other. As a result, the coil device 10 can be thin in the array direction of the first core 20a, the second core 20b, and the third core 20c, and the coil device 10 can effectively be downsized.

In the present embodiment, the first lateral part 31a (31b) is opposed to the lateral surfaces of the first core 20a and the third core 20c, and the second lateral part 41a (41b) is opposed to the lateral surfaces of the second core 20b and the third core 20c. Thus, the first lateral part 31a (31b) can widely be exposed to the laterals of the first core 20a and the third core 20c, and the second lateral part 41a (41b) can widely be exposed to the laterals of the second core 20b and the third core 20c. Thus, solder fillets can sufficiently be formed on the first lateral part 31a (31b) and the second lateral part 41a (41b), and the solder fillets can effectively increase the mounting strength for the mounting board.

When the coils 30 and 40 and the cores 20a, 20b, and 20c are combined in the manufacture of the coil device 10, the cores 20a and 20c can laterally be fixed by the first lateral parts 31a and 31b, and the cores 20b and 20c can laterally be fixed by the second lateral parts 41a and 41b. Thus, the positions of the respective cores 20a, 20b, and 20c can be prevented from being shifted by the first lateral parts 31a and 31b and the second lateral parts 41a and 41b.

In the present embodiment, the first lateral part 31a (31b) extends from the lateral surfaces to the bottom surfaces of the first core 20a and the third core 20c, and the second lateral part 41a (41b) extends from the lateral surfaces to the bottom surfaces of the second core 20b and the third core 20c. Thus, a part of the first lateral part 31a (31b) extending on the bottom surface of the core 20a (20b) (mountable part 32a (32b)) can be connected as a mounting surface with the mounting board, and a part of the second lateral part 41a (41b) extending on the bottom surface of the core 20b (20c) (mountable part 42a (42b)) can be connected as a mounting surface with the mounting board.

In the present embodiment, the first core 20a, the second core 20b, and the third core 20c are formed to be longer perpendicularly to the board surface of the mounting board. Thus, the width of the coil device 10 can be smaller than the height of the coil device 10, and a plurality of coil devices 10 can be mounted on the mounting board at high density.

In the present embodiment, the third core 20c is disposed between the first core 20a and the second core 20b; the first coil 30 is disposed between the first core 20a and the third core 20c; the second coil 40 is disposed between the second core 20b and the third core 20c; the plate surfaces of the first coil 30 (connection part 34) and the second coil 40 (connection part 44) are opposed to each other with the third core 20c interposed therebetween; the first coil 30 is partly (first lateral parts 31a and 31b) exposed to the lateral of the first core 20a; and the second coil 40 is partly (second lateral parts 41a and 41b) exposed to the lateral of the second core 20b. It is thereby possible to obtain the coil device 10 with symmetry about the third core 20c and favorable magnetic characteristics.

### Second Embodiment

Except for the following matters, a coil device 110 according to Second Embodiment of the present invention is similar to the coil device 10 according to First Embodiment and demonstrates similar effects. Their overlapping matters are not explained. In the figures, common members are provided with common references.

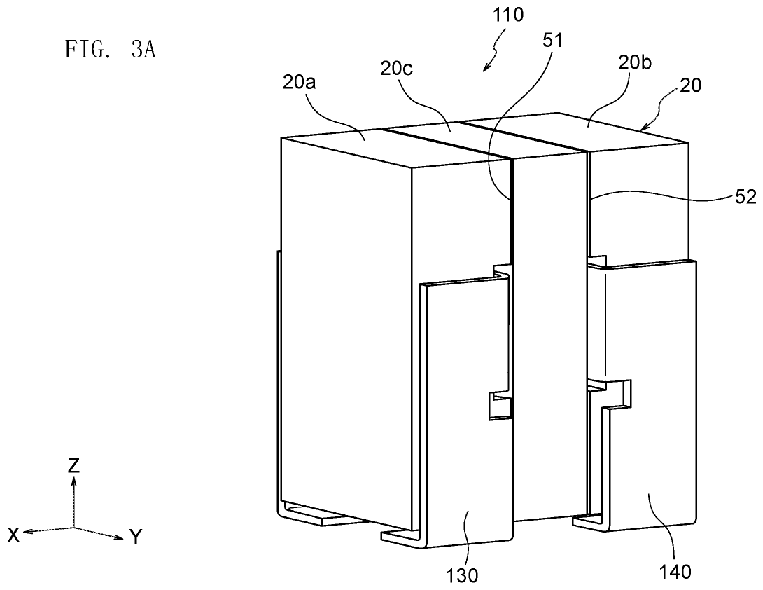

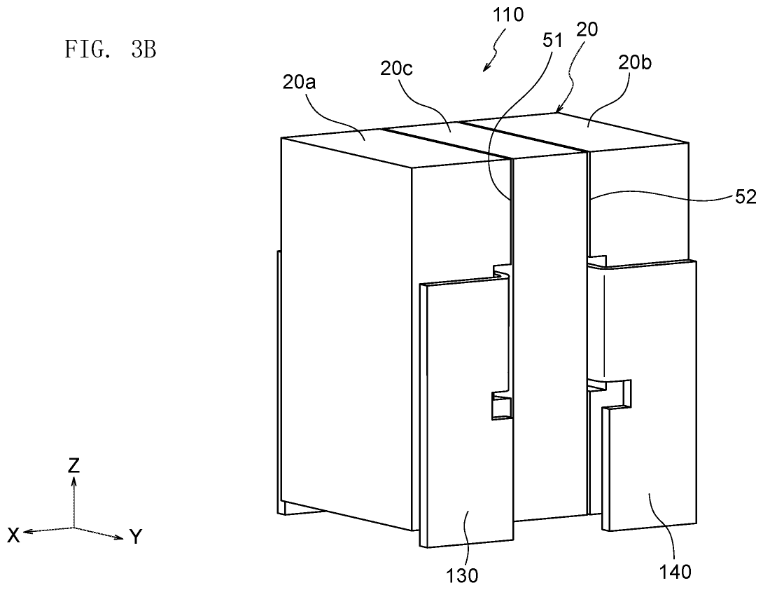

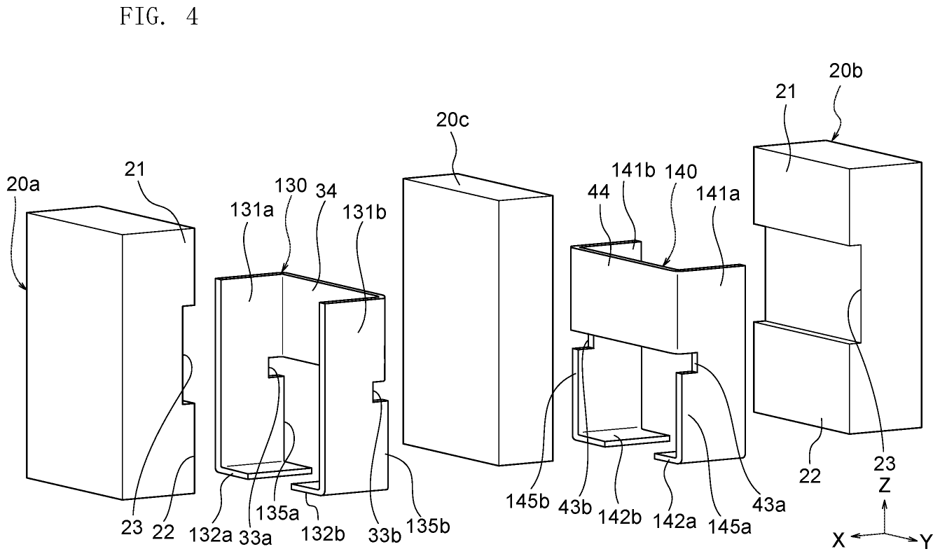

As shown in FIG. 3A, the coil device 110 includes a first coil 130 and a second coil 140. As shown in FIG. 4, the first coil 130 has first lateral parts 131a and 131b, and the first lateral part 131a (131b) has a first lateral protrusion part 135a (135b) and a first mountable part 132a (132b).

As clearly shown in comparison between FIG. 4 and FIG. 2, the first lateral protrusion part 135a (135b) is different from the first lateral protrusion part 35a (35b) of First Embodiment in that the first lateral protrusion part 135a (135b) has a small protrusion length on one side in the X-axis direction.

For more detail, the protrusion length of the first lateral protrusion part 135a (135b) from the base of the first concave part 33a (33b) shown in FIG. 4 is a substantially half of that of the first lateral protrusion part 35a (35b) from the base of the first concave part 33a (33b) shown in FIG. 2. The first lateral protrusion part 135a (135b) protrudes to substantially the same position as the connection part 34 on one side in the X-axis direction.

In the present embodiment, as shown in FIG. 3A and FIG. 4, the first lateral protrusion part 135a (135b) is not thereby disposed to range over the lateral surfaces of the first core 20a and the third core 20c at the lower ends of the cores 20a and 20c in the Z-axis direction, but is disposed only on the lateral surface of the first core 20a. The position of the end of the first lateral protrusion part 135a (135b) on one side in the X-axis direction (negative side in the X-axis direction) is substantially the same as that of the second outer leg part 22 on one side in the X-axis direction.

The first mountable part 132a (132b) is different from the first mountable part 32a (32b) of First Embodiment in that the first mountable part 132a (132b) has a smaller length in the X-axis direction. In the present embodiment, as mentioned above, the first lateral protrusion part 135a (135b) has a smaller protrusion length on one side in the X-axis direction, and the first lateral part 131a (131b) thereby has a smaller length in the X-axis direction. Thus, the length of the first mountable part 132a (132b) in the X-axis direction is correspondingly smaller than that of the first mountable part 32a (32b) of First Embodiment.

The second coil 140 has second lateral parts 141a and 141b, and the second lateral part 141a (141b) has a second lateral protrusion part 145a (145b) and a second mountable part 142a (142b). The structure of each part of the second lateral part 141a (141b) is similar to that of the first lateral part 131a (131b). Thus, their overlapping matters are not explained in detail.

As shown in FIG. 3A and FIG. 4, the second lateral protrusion part 145a (145b) is not disposed to range over the lateral surfaces of the second core 20b and the third core 20c at the lower ends of the cores 20b and 20c in the Z-axis direction, but is disposed only on the lateral surface of the second core 20b. The position of the end of the second lateral protrusion part 145a (145b) on the other side in the X-axis direction (positive side in the X-axis direction) is substantially the same as that of the second outer leg part 22 on the other side in the X-axis direction.

Effects similar to those of First Embodiment are obtained in the present embodiment. In addition, each of the first lateral protrusion part 135a (135b) and the second lateral protrusion part 145a (145b) has a comparatively small protrusion length in the X-axis direction in the present embodiment. Thus, the distance between the first lateral protrusion part 135b (135a) and the second lateral protrusion part 145a (145b) in the X-axis direction is large, and the generation of short circuit failure therebetween can be prevented.

### Third Embodiment

Except for the following matters, a coil device 210 according to Third Embodiment of the present invention is similar to the coil device 110 according to Second Embodiment and demonstrates similar effects. Their overlapping matters are not explained. In the figures, common members are provided with common references.

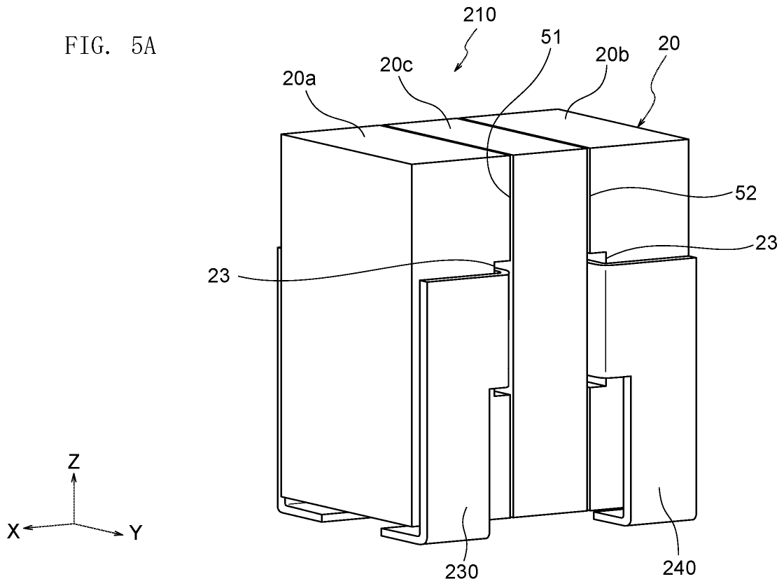

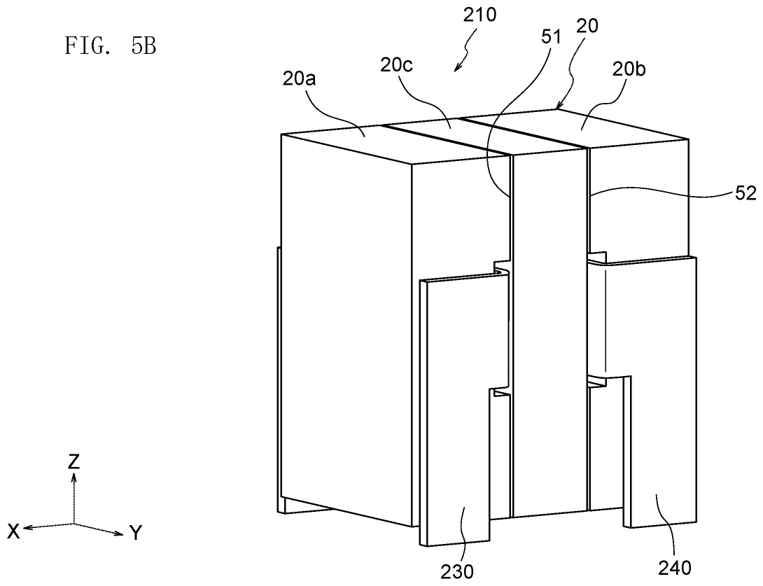

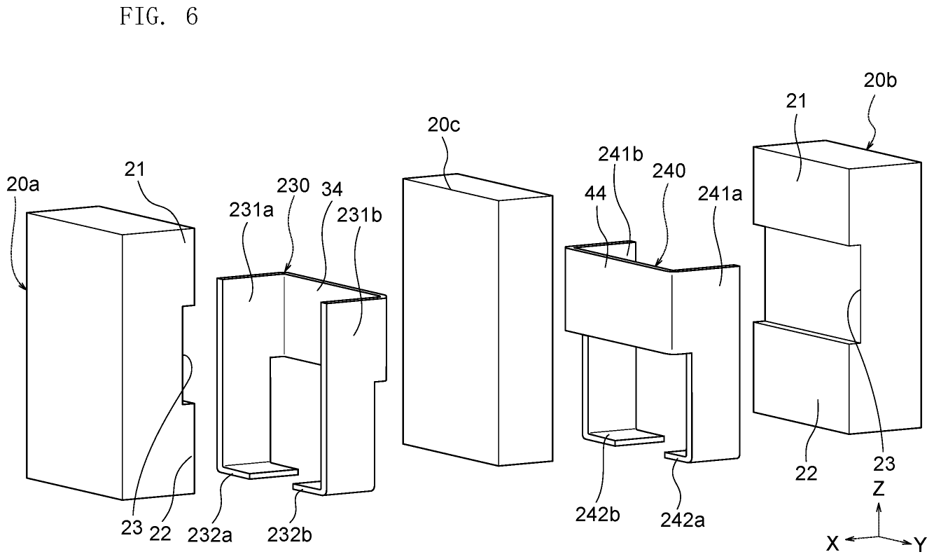

As shown in FIG. 5A, the coil device 210 includes a first coil 230 and a second coil 240. As shown in FIG. 6, the first coil 230 has first lateral parts 231a and 231b, and the first lateral part 231a (231b) has a first mountable part 232a (232b).

As clearly shown in comparison between FIG. 6 and FIG. 4, the first lateral part 231a (231b) shown in FIG. 6 is provided with neither the first lateral protrusion part 135b (135a) shown in FIG. 4 nor a component corresponding to the first lateral protrusion part 135b (135a). Since the first lateral protrusion part 135a (135b) is not formed, the first concave part 33a (33b) shown in FIG. 4 is not formed.

In the present embodiment, as shown in FIG. 5A and FIG. 6, the first lateral part 231a (231b) thereby extends only to the inner side of the end of the second outer leg part 22 on one side in the X-axis direction (negative side in the X-axis direction) at the lower end of the first core 20a in the Z-axis direction. The position of the end of the first lateral part 231a (231b) on one side in the X-axis direction is substantially the same as that of the base of the concave part 23 of the first core 20a or is closer to the other side of the base of the concave part 23 of the first core 20a in the X-axis direction.

The first mountable part 232a (232b) is different from the first mountable part 132a (132b) of Second Embodiment in that the first mountable part 232a (232b) has a further smaller length in the X-axis direction. In the present embodiment, since the first lateral protrusion part 135a (135b) is not formed as mentioned above, the first lateral part 231a (231b) has a small length in the X-axis direction. Thus, the length of the first mountable part 232a (232b) in the X-axis direction is correspondingly smaller than that of the first mountable part 132a (132b) of Second Embodiment.

The second coil 240 has second lateral parts 241a and 241b, and the second lateral part 241a (241b) has a second mountable part 242a (242b). The structure of each part of the second lateral part 241a (241b) is similar to that of the first lateral part 231a (231b). Thus, their overlapping matters are not explained in detail.

As shown in FIG. 5A and FIG. 6, the second lateral part 241a (241b) thereby extends only to the inner side of the end of the second outer leg part 22 on the other side in the X-axis direction (positive side in the X-axis direction) at the lower end of the second core 20b in the Z-axis direction. The position of the end of the second lateral part 241a (241b) on the other side in the X-axis direction is substantially the same as that of the base of the concave part 23 of the second core 20b or is closer to one side of the base of the concave part 23 of the second core 20b in the X-axis direction.

Effects similar to those of Second Embodiment are also obtained in the present embodiment. In addition, since the first lateral protrusion part 135a (135b) and the second lateral protrusion part 145a (145b) shown in FIG. 4 are not formed, the present embodiment can effectively prevent the generation of short circuit failure compared to the coil device 110 according to Second Embodiment.

### Fourth Embodiment

Except for the following matters, a coil device 310 according to Fourth Embodiment of the present invention is similar to the coil device 210 according to Third Embodiment and demonstrates similar effects. Their overlapping matters are not explained. In the figures, common members are provided with common references.

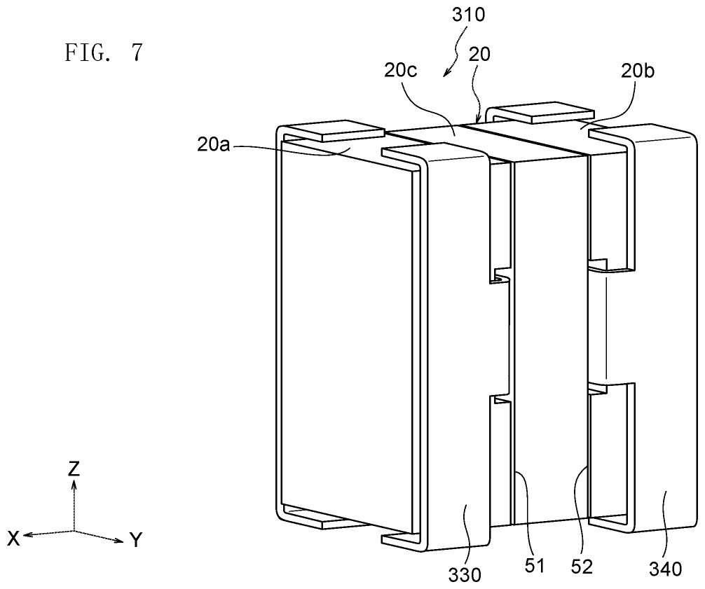

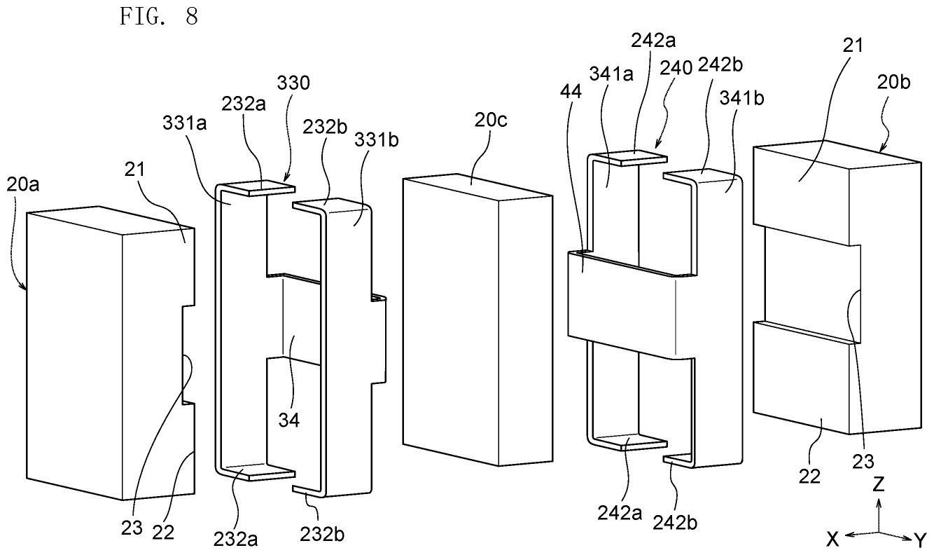

As shown in FIG. 7, the coil device 310 includes a first coil 330 and a second coil 340. As shown in FIG. 8, the first coil 330 has first lateral parts 331a and 331b, and the second coil 340 has second lateral parts 341a and 341b. The structure of each part of the second lateral part 341a (341b) is similar to that of the first lateral part 331a (331b). Thus, their overlapping matters are not explained in detail.

As clearly shown in comparison between FIG. 8 and FIG. 6, the first lateral part 331a (331b) is different from the first lateral part 231a (231b) of Third Embodiment in that the first lateral part 331a (331b) extends not only downward in the Z-axis direction but upward in the Z-axis direction.

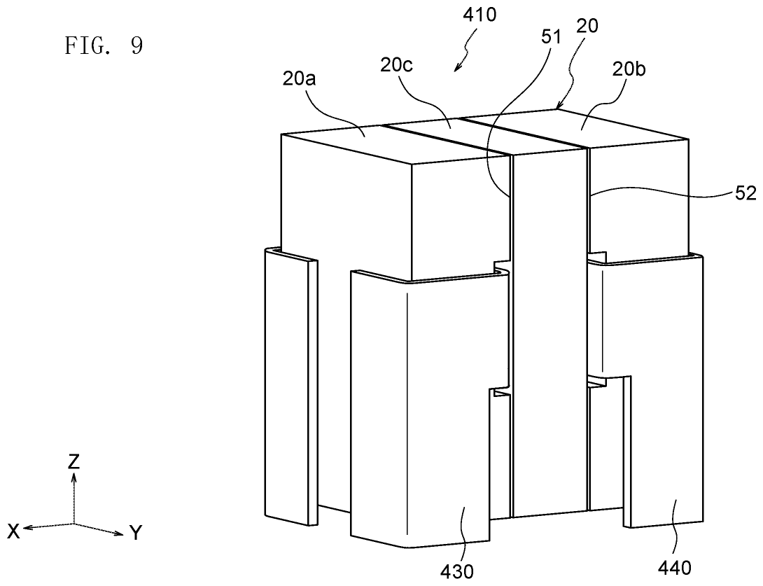

A lower part and an upper part of the first lateral part 331a (331b) in the Z-axis direction with the connection part 34 interposed therebetween have a similar shape. Thus, the overall shape of the coil device 310 is the same even if the coil device 310 is turned upside down from the state of FIG. 9.

The lower part and the upper part of the first lateral part 331a (331b) in the Z-axis direction with the connection part 34 interposed therebetween have a similar function. Thus, a solder fillet can be formed on the upper part of the first lateral part 331a (331b) in the Z-axis direction with the connection part 34. The first mountable part 232a (232b) formed on the same part functions as a connection surface with the mounting board. Thus, the coil device 310 can be connected with the mounting board via the first mountable part 232a (232b) formed on the same part.

Effects similar to those of Third Embodiment are also obtained in the present embodiment. In the present embodiment, the first lateral part 331a (331b) extends from the lateral surface to the top surface of the first core 20a, and the second lateral part 341a (341b) extends from the lateral surface to the top surface of the second core 20b. Thus, the mounting surface can be formed not only on the bottom surface of the coil device 310 but on the top surface of the coil device 310. Thus, the coil device 310 can be mounted on the mounting board even if the coil device 310 is upside down (the top surface and the bottom surface are reversed), and the coil device 310 is easily mounted.

### Fifth Embodiment

Except for the following matters, a coil device 410 according to Fifth Embodiment of the present invention is similar to the coil device 210 according to Third Embodiment and demonstrates similar effects. Their overlapping matters are not explained. In the figures, common members are provided with common references.

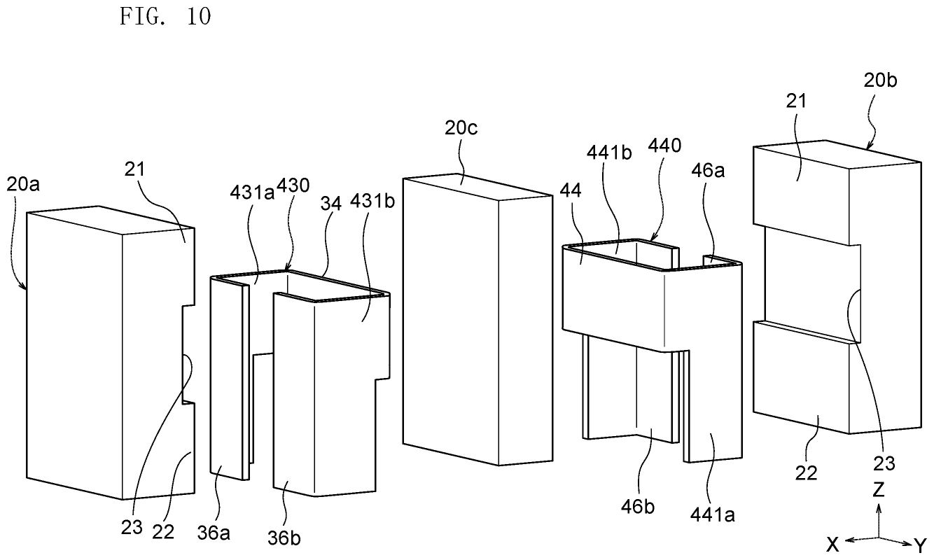

As shown in FIG. 9, the coil device 410 includes a first coil 430 and a second coil 440. As shown in FIG. 10, the first coil 430 has first lateral parts 431a and 431b, and the second coil 440 has second lateral parts 441a and 441b. The structure of each part of the second lateral part 441a (441b) is similar to that of the first lateral part 431a (431b). Thus, their overlapping matters are not explained in detail.

As clearly shown in comparison between FIG. 10 and FIG. 6, the first lateral part 431a (431b) is different from the first lateral part 231a (231b) of Third Embodiment in that the first lateral part 431a (431b) does not have the first mountable part 232a (232b) but has a first outer end part 36a (36b), and the second lateral part 441a (441b) is different from the second lateral part 241a (241b) of Third Embodiment in that the second lateral part 441a (441b) does not have the second mountable part 242a (242b) but has a second outer end part 46a (46b).

The first outer end part 36a (36b) has a plate shape (flat shape) parallel to the YZ plane and has a long shape in the Z-axis direction. The first outer end part 36a (36b) extends downward in the Z-axis direction and is connected with the end of the first lateral part 431a (431b) (main part of the first lateral part 431a (431b)) on the other side in the X-axis direction.

As shown in FIG. 9, the first outer end part 36a (36b) extends substantially in parallel to the end surface of the first core 20a on the other side in the X-axis direction, and the first outer end part 36a (36b) and the end surface of the first core 20a on the other side in the X-axis direction are opposed to each other in the X-axis direction. Likewise, the second outer end part 46a (46b) extends substantially in parallel to the end surface of the second core 20c on one side in the X-axis direction, and the second outer end part 46a (46b) and the end surface of the second core 20c on one side in the X-axis direction are opposed to each other in the X-axis direction.

A space may be formed between the first outer end part 36a (36b) and the end surface of the first core 20a on the other side in the X-axis direction, or the first outer end part 36a (36b) may be in contact with this end surface. A space may be formed between the second outer end part 46a (46b) and the end surface of the second core 20b on one side in the X-axis direction, or the second outer end part 46a (46b) may be in contact with this end surface.

Effects similar to those of Third Embodiment are also obtained in the present embodiment. In the present embodiment, the first lateral part 431a (431b) extends from the lateral surface to the end surface of the first core 20a, and the second lateral part 441a (441b) extends from the lateral surface to the end surface of the second core 20b. Thus, a solder fillet can be formed on a part of the first lateral part 431a (431b) located near the end surface of the first core 20a (first outer end part 36a (36b)), and a solder fillet can be formed on a part of the second lateral part 441a (441b) located near the end surface of the second core 20b (second outer end part 46a (46b)). These solder fillets can increase the mounting strength for the mounting board.

### Sixth Embodiment

Except for the following matters, a coil device 510 according to Sixth Embodiment of the present invention is similar to the coil device 210 according to Third Embodiment and demonstrates similar effects. Their overlapping matters are not explained. In the figures, common members are provided with common references.

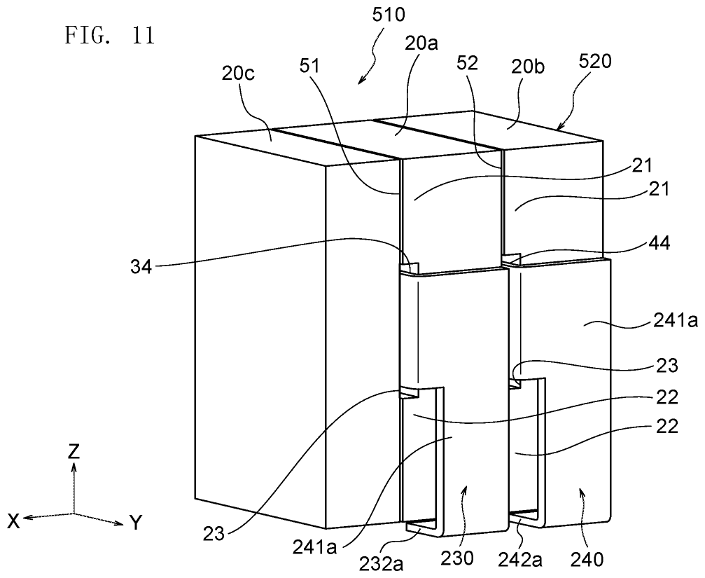

As shown in FIG. 11, the coil device 510 includes a core 520. As clearly shown in comparison between FIG. 11 and FIG. 5A, the arrangement of the cores 20a, 20b, and 20c of the core 520 is different from that of the cores 20a, 20b, and 20c in Third Embodiment. For more detail, the third core 20c, the first core 20a, and the second core 20b of the present embodiment are arranged in this order toward the negative side in the X-axis direction. That is, among the three cores 20a, 20b, and 20c of the present embodiment, the third core 20c is disposed at the end on the positive side in the X-axis direction, and the first core 20a is interposed by the third core 20c and the second core 20b.

In the core 520, the direction of the first core 20a is different from that of Third Embodiment. For more detail, the first core 20a is disposed so that the outer leg part 21 (22) protrudes on the positive side in the X-axis direction, and the direction of the first core 20a of the present embodiment is opposite to that of Third Embodiment in the X-axis direction. In the present embodiment, the first core 20a and the second core 20b thereby have the same direction in the X-axis direction.

In the coil device 510, the direction of the first coil 230 is different from that of Third Embodiment. For more detail, the direction of the first coil 230 is opposite to that of the second coil 240 in the X-axis direction in Third Embodiment as shown in FIG. 5A, but the first coil 230 and the second coil 240 have the same direction in the X-axis direction in the present embodiment as shown in FIG. 11.

As long as the coil 230 (240) is contained in the core 520 (interposed by some of the cores 20a, 20b, and 20c), the arrangement and direction of the cores 20a, 20b, and 20c or the direction of the coil 30 (40) may properly be changed as mentioned above. In this case, effects similar to those of Third Embodiment are also obtained.

### Seventh Embodiment

Except for the following matters, a coil device 610 according to Seventh Embodiment of the present invention is similar to the coil device 510 according to Sixth Embodiment and demonstrates similar effects. Their overlapping matters are not explained. In the figures, common members are provided with common references.

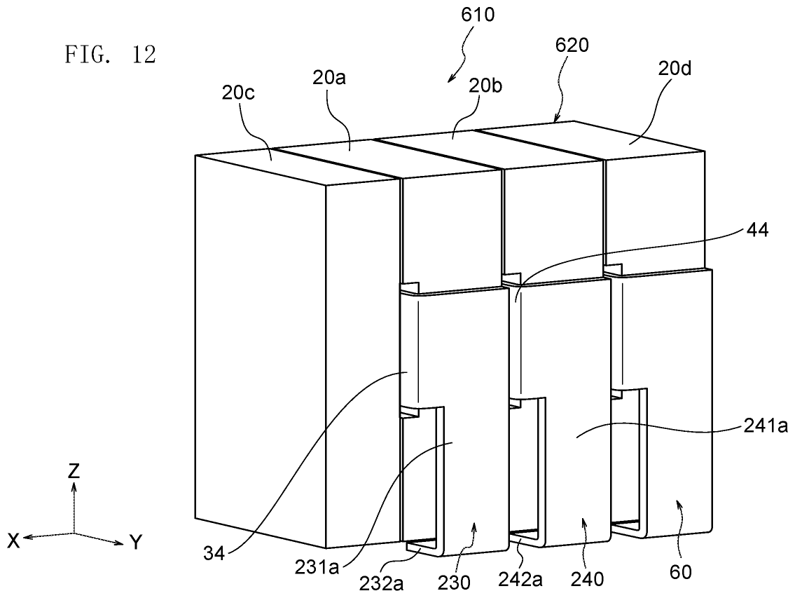

As shown in FIG. 12, the coil device 610 includes a core 620 and a third coil 60. In addition to the first core 20a, the second core 20b, and the third core 20c, the core 620 includes a fourth core 20d. The shape of the fourth core 20d corresponds to that of the first core 20a or the second core 20b. In the illustrated example, the fourth core 20d and the first core 20a or the second core 20b have the same shape. The fourth core 20d is disposed while facing the same direction as the first core 20a and the second core 20b in the X-axis direction.

The shape of the third coil 60 corresponds to that of the first coil 30 or the second coil 40. In the illustrated example, the third coil 60 and the first coil 30 or the second coil 40 have the same shape. The third coil 60 is disposed while facing the same direction as the first coil 30 and the second coil 40 in the X-axis direction.

Effects similar to those of Sixth Embodiment are also obtained in the present embodiment. In addition, the present embodiment further includes “n” cores (one core in the illustrated example) corresponding to the first core 20a or the second core 20b (fourth core 20d). For example, the coil device 610 having a high inductance value can be obtained by further adding “n” cores corresponding to the first core 20a or the second core 20b (fourth core 20d) and correspondingly adding “n” coils (one coil in the illustrated example) corresponding to the first coil 230 or the second coil 240 (third coil 60). Even if the number of cores and coils is increased, the coil device 610 can be downsized (space saving) by interposing each of the coils 30, 40, and 60 between the cores 20a, 20b, 20c, and 20d.

### Eighth Embodiment

Except for the following matters, a coil device 710 according to Eighth Embodiment of the present invention is similar to the coil device 610 according to Seventh Embodiment and demonstrates similar effects. Their overlapping matters are not explained. In the figures, common members are provided with common references.

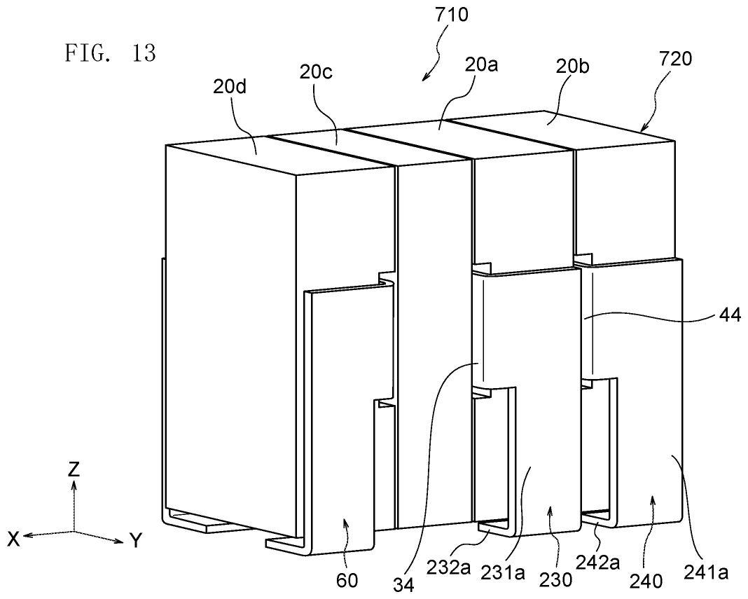

The coil device 710 includes a core 720. As clearly shown in comparison between FIG. 13 and FIG. 12, the core 720 of the present embodiment is different from the core 620 of Seventh Embodiment in that the fourth coil 20d of the present embodiment is disposed next to the third core 20c while the fourth coil 20d of Seventh Embodiment is disposed next to the second coil 20b. The fourth core 20d of the present embodiment is disposed so that the outer leg part 21 (22) is opposed to the end surface of the third core 20c on the other side in the X-axis direction.

The third coil 60 is disposed to be interposed between the third core 20c and the fourth core 20d arranged next to each other. The third coil 60 is disposed while facing the opposite direction to the first coil 30 and the second coil 40 in the X-axis direction. Incidentally, for example, the coil device 710 is also obtained by disposing the fourth core 20d to be next to the second core 20b shown in FIG. 5A and further interposing the third coil 60 between the second core 20b and the fourth core 20d arranged next to each other.

As long as the coils 30, 40, and 60 are arranged in the core 20 (arranged to be interposed by some of the cores 20a, 20b, 20c, and 20d), the arrangement and direction of the cores 20a, 20b, 20c, and 20d or the direction of the coil 30 (40, 60) may properly be changed. In this case, effects similar to those of Seventh Embodiment are also obtained.

Incidentally, the present invention is not limited to the above-mentioned embodiments and may variously be changed within the scope of the present invention.

In First Embodiment, the first coil 30 and the second coil 40 may have different shapes. This is also the case with Second Embodiment to Eighth Embodiment.

In First Embodiment, the first mountable part 32a (32b) and the second mountable part 42a (42b) are not indispensable and may not be formed as shown in FIG. 1C. In this case, the structure of the coil 30 (40) can be simplified.

In Second Embodiment, the first mountable part 132a (132b) and the second mountable part 142a (142b) are not indispensable and may not be formed as shown in FIG. 3B. In this case, the structure of the coil 130 (140) can be simplified.

In Third Embodiment, the first mountable part 232a (232b) and the second mountable part 242a (242b) are not indispensable and may not be formed as shown in FIG. 5B. In this case, the structure of the coil 230 (240) can be simplified.

The technique of Fourth Embodiment may be applied to the coil device 10 of First Embodiment. That is, the first lateral part 31a (31b) of the first coil 30 shown in FIG. 1A (also, the second lateral part 41a (41b) of the second coil 40) may extend not only downward above the connection part 34 but upward below the connection part 34 in the Z-axis direction. Likewise, the technique of Fourth Embodiment may be applied to the coil devices of Second Embodiment, Third Embodiment, and Fifth Embodiment to Eighth Embodiment.

The technique of Fifth Embodiment may be applied to the coil device 10 of First Embodiment. That is, the first lateral part 31a (31b) of the first coil 30 shown in FIG. 1A (also, the second lateral part 41a (41b) of the second coil 40) may be provided with the first outer end part 36a (36b) shown in FIG. 10. Likewise, the technique of Fifth Embodiment may be applied to the coil devices of Fourth Embodiment and Sixth Embodiment to Eighth Embodiment.

Sixth Embodiment may employ the coil 30 (40) or so of First Embodiment, Second Embodiment, Fourth Embodiment, or Fifth Embodiment. At this time, the size or so of the coil 30 (40) or so may be changed as necessary. This is the case with Seventh Embodiment and Eighth Embodiment.

In Seventh Embodiment, the coil device 610 is provided with only one core corresponding to the first core 20a or the second core 20b (fourth core 20d), but the number of these cores may be two or more. This is also the case with Eighth Embodiment.

In First Embodiment, the concave part 23 of the first core 20a and/or the concave part 23 of the second core 20b may be formed to be shifted toward the bottom surface or the top surface of the first core 20a or the second core 20b. In this structure, the magnetic path of the first coil 30 or the second coil 40 can be changed, and magnetic characteristics of the coil device 30 can be adjusted. This is also the case with Second Embodiment to Eighth Embodiment.

In First Embodiment, any of the first core 20a, the second core 20b, and the third core 20c may be formed from split cores. In this structure, a gap can be formed between the split cores in combining them, and the magnetic coupling between the first coil 30 and the second coil 40 can be adjusted. This is also the case with Second Embodiment to Eighth Embodiment.

In First Embodiment, the first core 20a and the second core 20b may be made from magnetic material, and the third core 20c may be made from nonmagnetic material. When only the third core 20c is made from nonmagnetic material, for example, the inductance value of the coil device 10 can be adjusted to a desired value. This is also the case with Second Embodiment to Eighth Embodiment.

In First Embodiment, the core 20 is formed from the first and second cores 20a and 20b having a U shape and the third core 20c having an I shape, but the core 20 may be formed by, for example, combining a H-shaped core and two I-shaped cores. This is also the case with Second Embodiment to Sixth Embodiment. In Seventh Embodiment and Eighth Embodiment, a H-shaped core may be employed.

### DESCRIPTION OF THE REFERENCE NUMERICAL

10, 110, 210, 310, 410, 510, 610, 710 . . . coil device
20, 520, 620, 720 . . . core
20a . . . first core
20b . . . second core
20c . . . third core
20d . . . fourth core
21 . . . first outer leg part
22 . . . second outer leg part
23 . . . concave part
30, 130, 230, 330, 430 . . . first coil
31a, 31b, 131a, 131b, 231a, 231b, 331a, 331b, 431a, 431b . . . first lateral part
32a, 32b, 132a, 132b, 232a, 232b . . . first mountable part
33a, 33b . . . first concave part
34 . . . first connection part
35a, 35b, 135a, 135b . . . first lateral protrusion part
36a, 36b . . . first outer end part
40, 140, 240, 340, 440 . . . second coil
41a, 41b, 141a, 141b, 241a, 241b, 341a, 341b, 441a, 441b . . . second lateral par
42a, 42b, 142a, 142b, 242a, 242b . . . second mountable part
43a, 43b . . . second concave part
44 . . . second connection part
45a, 45b, 145a, 145b . . . second lateral protrusion part
46a, 46b . . . second outer end part
51 . . . first gap
52 . . . second gap

What is claimed is:

1. A coil device comprising:
a pair of first core and second core;
a third core disposed next to the first core or the second core; and
a pair of first coil and second coil each disposed between any two of the first core, the second core, and the third core next to each other,
wherein plate surfaces of the first coil and the second coil are opposed to each other, and
wherein each of the first coil and the second coil is partly exposed in a lateral direction of the first core, the second core, or the third core.

2. The coil device according to claim 1, wherein
the first coil includes a pair of plate-like first lateral parts and a plate-like first connection part connecting the pair of first lateral parts, and
the second coil includes a pair of plate-like second lateral parts and a plate-like second connection part connecting the pair of second lateral parts.

3. The coil device according to claim 2, wherein each of the first connection part and the second connection part is disposed between any two of the first core, the second core, and the third core next to each other.

4. The coil device according to claim 2, wherein
at least either of the first lateral parts faces a lateral surface of any of the first core, the second core, and the third core, and
at least either of the second lateral parts faces a lateral surface of any of the first core, the second core, and the third core.

5. The coil device according to claim 3, wherein
at least either of the first lateral parts faces a lateral surface of any of the first core, the second core, and the third core, and
at least either of the second lateral parts faces a lateral surface of any of the first core, the second core, and the third core.

6. The coil device according to claim 4, wherein
at least either of the first lateral parts faces lateral surfaces of any two of the first core, the second core, and the third core, and
at least either of the second lateral parts faces lateral surfaces of any two of the first core, the second core, and the third core.

7. The coil device according to claim 5, wherein
at least either of the first lateral parts faces lateral surfaces of any two of the first core, the second core, and the third core, and
at least either of the second lateral parts faces lateral surfaces of any two of the first core, the second core, and the third core.

8. The coil device according to claim 2, wherein
at least either of the first lateral parts extends from a lateral surface to a bottom surface of any of the first core, the second core, and the third core, and
at least either of the second lateral parts extends from a lateral surface to a bottom surface of any of the first core, the second core, and the third core.

9. The coil device according to claim 3, wherein
at least either of the first lateral parts extends from a lateral surface to a bottom surface of any of the first core, the second core, and the third core, and
at least either of the second lateral parts extends from a lateral surface to a bottom surface of any of the first core, the second core, and the third core.

10. The coil device according to claim 4, wherein
at least either of the first lateral parts extends from a lateral surface to a bottom surface of any of the first core, the second core, and the third core, and
at least either of the second lateral parts extends from a lateral surface to a bottom surface of any of the first core, the second core, and the third core.

11. The coil device according to claim 2, wherein
at least either of the first lateral parts extends from a lateral surface to a top surface of any of the first core, the second core, and the third core, and
at least either of the second lateral parts extends from a lateral surface to a top surface of any of the first core, the second core, and the third core.

12. The coil device according to claim 2, wherein
at least either of the first lateral parts extends from a lateral surface to an end surface of any of the first core, the second core, and the third core, and
at least either of the second lateral parts extend from a lateral surface to an end surface of any of the first core, the second core, and the third core.

13. The coil device according to claim 1, wherein the first core, the second core, and the third core are formed to be long in a perpendicular direction to a board surface of a mounting board.

14. The coil device according to claim 1, wherein
the first core has a first concave part through which the first coil passes,
the second core has a second concave part through which the second coil passes, and
the first concave part or the second concave part is formed to be shifted toward a bottom surface or a top surface of the first core or the second core.

15. The coil device according to claim 1, further comprising “n” number of cores corresponding to the first core or the second core.

16. The coil device according to claim 2, further comprising “n” number of cores corresponding to the first core or the second core.

17. The coil device according to claim 1, wherein any of the first core, the second core, and the third core includes split cores.

18. The coil device according to claim 1, wherein
the first core and the second core are made from magnetic material, and
the third core is made from nonmagnetic material.

19. The coil device according to claim 1, wherein
the third core is disposed between the first core and the second core,
the first coil is disposed between the first core and the third core,
the second coil is disposed between the second core and the third core,
the plate surfaces of the first coil and the second coil are opposed to each other with the third core interposed therebetween,
the first coil is partly exposed in a lateral direction of the first core, and
the second coil is partly exposed in a lateral direction of the second core.

20. The coil device according to claim 2, wherein
the third core is disposed between the first core and the second core,
the first coil is disposed between the first core and the third core,
the second coil is disposed between the second core and the third core,
the plate surfaces of the first coil and the second coil are opposed to each other with the third core interposed therebetween,
the first coil is partly exposed in a lateral direction of the first core, and
the second coil is partly exposed in a lateral direction of the second core.
